(19) United States
(12) Patent Application Publication
(10) Pub. No.: US 2020/0337338 A1
(43) Pub. Date: Oct. 29, 2020

(54) PRODUCTION METHOD FOR RUMEN-BYPASSING PREPARATION, AND GRANULES OBTAINED BY MEANS OF PRODUCTION METHOD FOR RUMEN-BYPASSING PREPARATION

(71) Applicant: BIO SCIENCE CO., LTD., Anan-shi (JP)

(72) Inventors: Asuka OKUTANI, Anan-shi (JP); Noriyuki TOSANO, Anan-shi (JP); Fumiaki YOSHIKAWA, Anan-shi (JP); Hideki NANIWA, Anan-shi (JP)

(73) Assignee: BIO SCIENCE CO., LTD., Anan-shi (JP)

(21) Appl. No.: 16/323,349

(22) PCT Filed: Aug. 10, 2017
(86) PCT No.: PCT/JP2017/029178

§ 371 Date: Feb. 5, 2019

(30) Foreign Application Priority Data
Aug. 10, 2016 (JP) 2016-157719

(51) Int. Cl. A23K 40/35; A23K 50/10; A23K 20/142; A23K 20/174; A23K 20/158

(52) U.S. Cl. CPC A23K 40/35; A23K 50/10; A23K 20/158; A23K 20/174; A23K 20/142

(57) ABSTRACT

Provided is a method for producing a rumen-bypassing preparation which is produced at a low cost and simultaneously achieves the objects of protecting an active ingredient from release and decomposition in the first stomach and increasing release behavior in a target internal organ. A granular agent obtained thereby is also described. The method includes a step of applying vibration to a die head containing a melt of a coating agent for the rumen-bypassing preparation and a nutrient to bypass a rumen and having at least one injection port or to the melt, thereby injecting the melt from the injection port.

### TECHNICAL FIELD

The present invention relates to: a method for producing a rumen-bypassing preparation which is produced at a low cost and simultaneously achieves the objects of protecting an active ingredient from release and decomposition in the first stomach and increasing release behavior in a target internal organ; and the rumen-bypassing preparation obtained thereby.

### BACKGROUND ART

The development of some rumen-bypassing preparations has been advanced, and the rumen-bypassing preparations have been commercialized to protect active ingredients such as nutritional components from release and decomposition in the first stomachs in ruminants and improve the absorption of the active ingredients by the ruminants thereby. Some rumen-bypassing preparations have the shapes of granular agents and pellets. However, although enlarged dosage forms such as pellet shapes are easily protected from the release and decomposition of the active ingredients in the first stomachs, there is a problem that the enlarged dosage forms easily collapse in the mouths by mastication and are easily inhibited from releasing the active ingredients, and the utilization efficiency thereof is reduced.

Patent Literature 1 discloses that a method for releasing a melt of a mixture containing an active ingredient and an excipient from a vibrating nozzle and dropping the melt in a tower to obtain granules which exhibit persistence or a rapid release behavior at the bottom of a tower. However, the granules obtained by this method have a certain pore volume. Since the active ingredient is released rapidly or continuously, it is difficult to solve a problem that the active ingredient is protected from release and decomposition in the first stomach of a ruminant.

### CITATION LIST

### Patent Literature

Patent Literature 1: National Publication of International Patent Application No. H10-500899

### SUMMARY OF INVENTION

The present invention provides: a method for producing a rumen-bypassing preparation which is produced at a low cost and simultaneously achieves the objects of protecting an active ingredient from release and decomposition in a first stomach and increasing release behavior in a target internal organ; and the rumen-bypassing preparation obtained thereby.

The present inventors have revealed that while a melt of the components of the preparation filled in a die head is vibrated, the melt is injected from the die head to obtain a large amount of granules having a uniform particle size in a specific range in production of a rumen-bypassing preparation. The present inventors have also revealed that the uniformity of the particle size is improved especially by bringing a vibrator directly in contact with the melt and vibrating the melt and by adjusting the frequency of applied vibration to 1,000 Hz to 10,000 Hz. The present inventors have further revealed that the obtained preparation has an excellent dissolution property and excellent stability as a rumen-bypassing preparation. The present invention is an invention based on such knowledge.

That is, the following embodiments are provided according to the present invention.

(1) A method for producing a rumen-bypassing preparation, comprising applying vibration to a die head containing a melt of a coating agent for the rumen-bypassing preparation and a nutrient to bypass the rumen and having at least one injection port or the melt contained in the die head, thereby injecting the melt from the injecting port.
(2) The method according to the above-mentioned (1), wherein the vibration is vibration in the range of 1000 Hz to 10000 Hz.
(3) The method according to the above-mentioned (1) or (2), wherein the vibration is vibration in the range of 3000 Hz to 7000 Hz.
(4) The method according to any of the above-mentioned (1) to (3), wherein the vibration is applied to the melt through a vibrator exposed to the internal cavity of the die head and coming directly in contact with the melt.
(5) The method according to any of the above-mentioned (1) to (4), wherein the coating agent is a hydrogenated oil.
(6) The method according to the above-mentioned (5), wherein the hydrogenated oil is one or more hydrogenated oils selected from the group consisting of hydrogenated palm oil and hydrogenated rapeseed oil.
(7) The method according to any of the above-mentioned (1) to (6), wherein the coating agent further comprises one or more selected from the group consisting of fatty acids and lecithin.
(8) The method according to any of the above-mentioned (1) to (7), wherein the nutrient is an amino acid or a vitamin.
(9) The method according to any of the above-mentioned (1) to (8), wherein the nutrient is one or more nutrients selected from the group consisting of lysine, methionine, vitamin B and vitamin D.
(10) A rumen-bypassing preparation comprising a component to bypass a rumen and a carrier for bypassing the rumen, wherein the rumen-bypassing preparation is a granular agent wherein 40 weight/weight % or more of the total granules have particle sizes of 1000 to 1519 μm.
(11) A rumen-bypassing preparation comprising a component to bypass a rumen and a coating agent for the rumen-bypassing preparation, wherein the rumen-bypassing preparation is a granular agent wherein 50 weight/weight % or more of the total granules have particle sizes of 700 to 1500 μm.
(12) The rumen-bypassing preparation according to the above-mentioned (10) or (11), wherein the rumen-bypassing preparation has a pore volume of 5 μL/g or more.
(13) A rumen-bypassing preparation obtained by the method according to any of the above-mentioned (1) to (9).

According to the present invention, a rumen-bypassing preparation having particle sizes of 700 μm or more is efficiently obtained at a low cost advantageously. According to the present invention, the obtained rumen-bypassing preparation has resistance to dissolution in the first stomach and high long-term storage stability advantageously.

### BRIEF DESCRIPTION OF DRAWINGS

FIG. 1 is a sectional schematic diagram of an example of a die head which can be used for granulating granules.

FIG. 2 is a sectional schematic diagram of a granule of an obtained rumen-bypassing preparation.

FIG. 3 is a sectional schematic diagram of a granule of an obtained rumen-bypassing preparation.

FIG. 4 is photographs of granules obtained in Example 1 and granules obtained by the conventional spraying method.

FIG. 5 shows an analysis result of the pore volume of granules obtained in Example 1 by mercury porosimetry.

FIG. 6 shows an analysis result of the pore volume of granules obtained in Example 2 by mercury porosimetry.

FIG. 7 shows an analysis result of the pore volume of granules obtained in Example 3 by mercury porosimetry.

### DESCRIPTION OF EMBODIMENTS

The “rumen-bypassing preparation” which is used herein means a preparation which is a granular agent containing a component to bypass the rumen (namely, the first stomach) and a carrier for bypassing the rumen mixed therewith, or a granular agent having a component to bypass the rumen and a carrier (or coating layer) therearound, and thereby can prevent the component from being dissolved and decomposed in the first stomach of a ruminant. The “carrier for bypassing the rumen” means a carrier used for protecting a useful component in the rumen (also occasionally called simply “protective agent” or “protective agent for bypassing the rumen”), and the “coating agent” means the carrier covering the useful ingredient herein. The term “carrier for bypassing the rumen” is synonymous with the “protective agent” or the “protective agent for bypassing the rumen”, and can be used interchangeably herein.

The “particle size” used herein is a particle size measured on the basis of the method for measuring particle size of the Japanese Pharmacopoeia. Unless otherwise specified, the “average particle size” means a number average particle size herein.

In the present invention, provided is a method for producing a rumen-bypassing preparation, comprising applying vibration to a die head containing a melt of a carrier for bypassing the rumen and a component to bypass the rumen and having at least one injection port or the melt, thereby injecting the melt from the injecting port.

A carrier for bypassing the rumen, wherein the melted carrier can be used in the spraying method can be used, and those skilled in the art can properly select and use the carrier. Examples of the carrier which can be used in the present invention are as follows. A carrier for bypassing the rumen, wherein the carrier has a melting point of 40° C. or more can be used. The melting point of the carrier for bypassing the rumen can be a temperature lower than a temperature at which the component to bypass the rumen is decomposed, and can, for example, 80° C. or less. Therefore, the carrier for bypassing the rumen can be a carrier having a melting point of 40° C. to 90° C., and can be a carrier having a melting point in the temperature range selected from, for example, 50° C. to 70° C., 60° C. to 80° C., 40° C. to 70° C. and 40° C. to 60° C.

Specific examples of such a carrier for bypassing the rumen include, but are not particularly limited to, wax, fatty acids, fatty acid salts, glycerophospholipids, and hydrogenated oils. Examples of the hydrogenated oils include hydrogenated castor oil, hydrogenated palm oil and hydrogenated rapeseed oil. Examples of the glycerophospholipids include lecithin.

When the “melt” is described herein, the “melt” is used including not only a melt in which the component to bypass the rumen is dissolved in the carrier completely but also a melt in which the component to bypass the rumen is dispersed in a form of granules in a melt of the carrier. The carrier for bypassing the rumen is usually liposoluble. Therefore, when a liposoluble component is used as an active ingredient, the active ingredient can be dissolved in the carrier. When a water-soluble component is used as an active ingredient, solid particles containing the water-soluble component can be dispersed in the carrier.

Examples of the component to bypass the rumen include nutrients. A nutrient is useful, for example, for preventing diseases of the ruminants and maintaining the health of the ruminants by supplying the nutrient to ruminants by a rumen-bypassing preparation. Examples of a nutrient which can be used in the present invention include amino acids, vitamins and salts thereof.

Examples of the amino acids include amino acids such as methionine and lysine. Examples of the vitamins include vitamin B1, B2, pantothenic acid, folic acid, nicotinic acid, vitamin C and vitamin E. The component to bypass the rumen may contain other additives (for example, food additives). Examples of the additives include, but are not particularly limited to, glucose and trimethylglycine (betaine).

The component to bypass the rumen may be particulate, and can be dispersed in a melt. When the component to bypass the rumen is provided in the form of particles, the particle size of the particles can be 600 μm or less, 500 μm or less, 400 μm or less, 300 μm or less, 200 μm or less, or 100 μm or less on the number average. The particle size may be smaller than the hole diameter of a jetting port as described below. As the particle size of the particles becomes smaller, the uniformity of the particle size of the obtained granular agent increases.

A die head comprises: an inlet port of a melt and an injection port of the melt. In the method of the present invention, a melt can be injected from the die head by applying vibration to the die head having at least one injection port or to the melt, and granular agents can be obtained. When vibration is applied, the whole die head can also be vibrated, or a vibrator which is exposed to the internal cavity of a die head and is directly in contact with the melt may be vibrated.

Enough vibration can be applied to inject the melt. The vibration can have a frequency of, for example, 1,000 Hz to 10,000 Hz, 3,000 Hz to 7,000 Hz, or 5,000 to 7,000 Hz. Although the frequency may be variable, and the frequency may be constant preferably.

In an embodiment of the present invention, when vibration is applied, the whole die head is vibrated, and the frequency can be 1,000 Hz to 10,000 Hz, 3,000 Hz to 7,000 Hz, or 5,000 to 7,000 Hz.

In an embodiment of the present invention, when vibration is applied, a vibrator which is exposed to the internal cavity of the die head and is directly in contact with the melt is vibrated. The frequency can be 1,000 Hz to 10,000 Hz, 3,000 Hz to 7,000 Hz, or 5,000 to 7,000 Hz.

In an embodiment of the present invention, when vibration is applied, a vibrator which is exposed to the internal cavity of the die head and is directly in contact with the melt is vibrated and the vibrator can be vibrated at a constant amplitude in the range of 3,000 to 7,000 Hz.

In an embodiment of the present invention, the vibration can have a P-P value of 1 mm to 10 mm. In an embodiment of the present invention, the vibration can have a P-P value of 3 mm to 7 mm, 4 mm to 6 mm, or around 5 mm. In an embodiment of the present invention, the vibration is a sine wave.

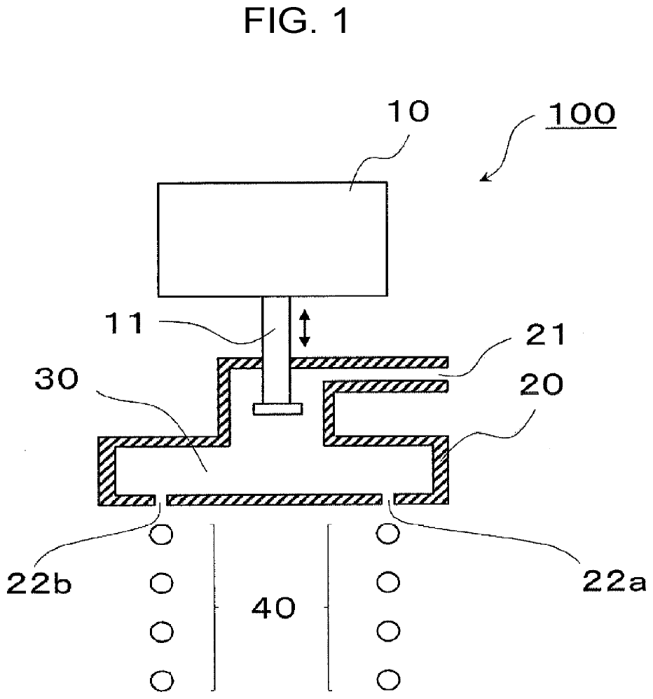

A die head will be described with reference to FIG. 1 hereinafter. However, the present invention is not interpreted by limiting the present invention by the non-limiting example of FIG. 1.

A die head 100 comprises the inlet port 21 of a melt, an internal cavity 30 and the injection port 22 of the melt. Although the die head 100 comprises two injection ports, which are indicated with 22a and 22b, in FIG. 1, the number of injection ports can be one or more, can be, for example, 8 to 32, and is not particularly limited. The die head comprises the internal cavity 30, and can be filled with the melt introduced from the inlet port 21. The internal cavity is connected with the injection ports 22 of the melt, and the melt is injected from the internal cavity 30 through the injection ports 22.

The die head 100 is further coupled to a vibration generator 10 comprising a vibrator 11. The vibration generator 10 can vibrate the vibrator 11 in the direction of the arrow of FIG. 1. The vibrator 11 is exposed to the internal cavity 30 of the die head, and vibration can be applied to the melt filled in the internal cavity 30 by the vibration of the vibrator 11. The melt is injected from the injection ports 22 to form granules 40 by applying vibration.

The injection ports 22 can have a die hole diameter of 0.5 to 1.0 mm, for example, 0.6 to 0.8 mm, or for example, around 0.7 mm. In an aspect of the present invention, die holes having a diameter which is around half the particle size of desired granules can be preferably used.

In the present invention, the above-mentioned die head 100 can be used for applying vibration to the melt.

The method of the present invention may further comprise cooling the injected melts. When the injected melt is cooled to a temperature of the melting point of a carrier or less, the injected melt solidifies to be a granular agent. The granular agent can be efficiently obtained by cooling. Since certain time is required for solidification, the melt is injected into cooled air from a height wherein enough time to solidify the melt can be secured, and the granular agent can be landed and collected with the melt solidified.

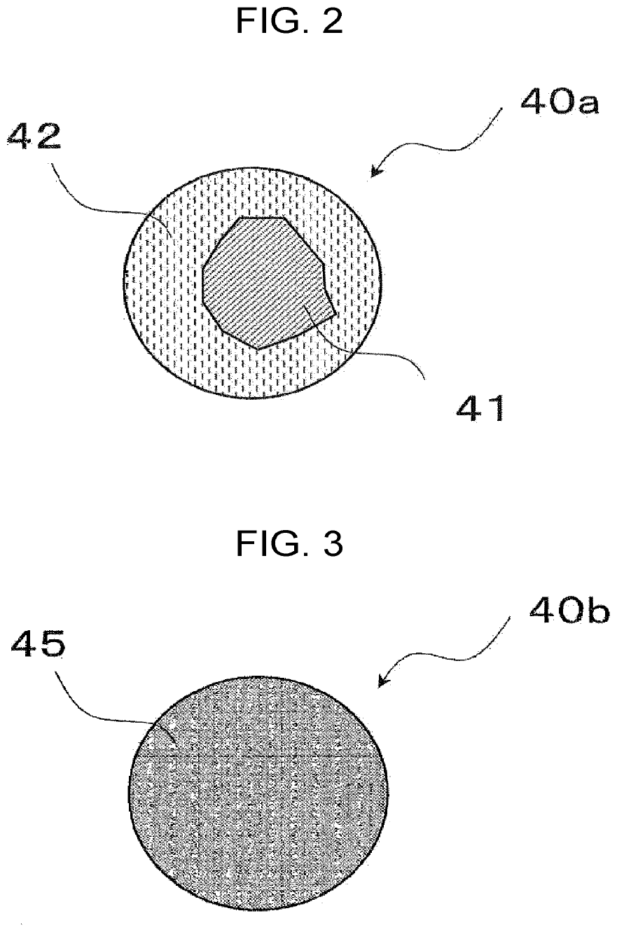

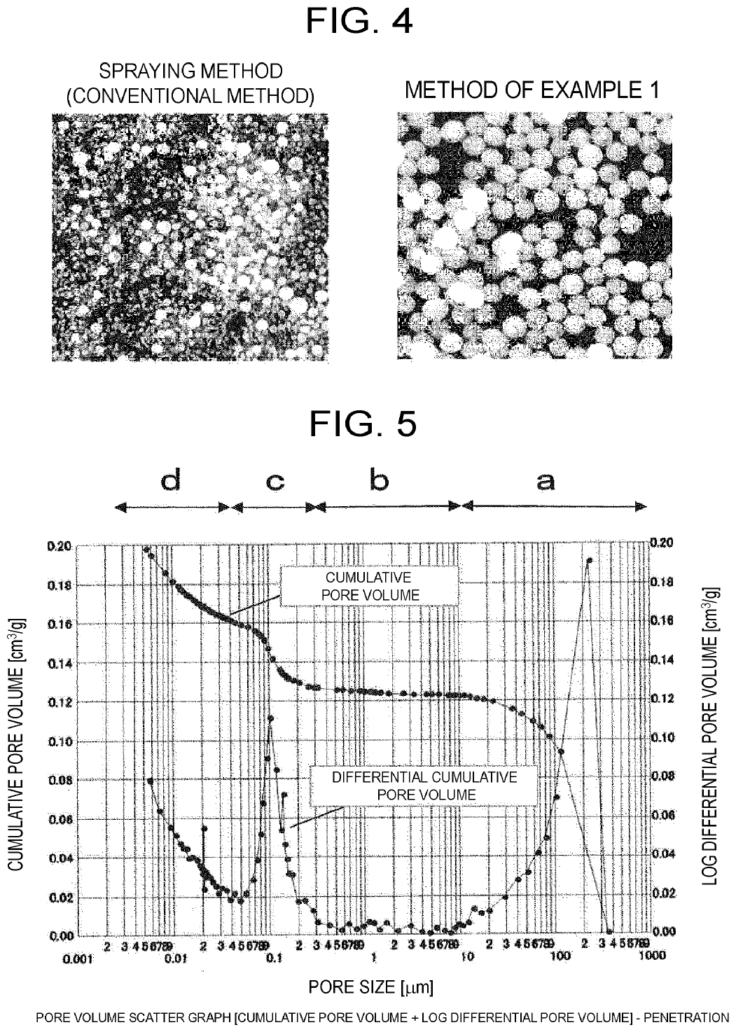

As to a solid preparation having a component to bypass the rumen and a carrier (or coating layer) therearound, a schematic diagram of the shape of the rumen-bypassing preparation which can be obtained by the method of the present invention is shown in FIG. 2. A granular agent 40a has ideally a substantially spherical shape in which a particle 41 of a component to bypass the rumen is covered with a coating agent 42. Although in FIG. 2 only one particle 41 is contained in the granular agent 40a, two or more may be contained. The particle size of the particle 41 of the component to bypass the rumen can be, for example, 500 μm or less, 400 μm or less, 300 μm or less, 200 μm or less, or 100 μm or less. As the particle size becomes smaller, the shape of the obtained granular agent 40 approaches to a spherical shape. As to a solid preparation having a carrier which dissolves a component to bypass the rumen, a schematic diagram of the shape of a rumen-bypassing preparation which can be obtained by the method of the present invention is shown in FIG. 3. A granular agent 40b comprises a carrier 45 dissolving the bypassed component.

The method of the present invention may further comprise introducing a melt of a carrier for bypassing the rumen and a nutrient to bypass the rumen into a die head.

Therefore, in the present invention, a method for producing a rumen-bypassing preparation, comprising:

introducing a melt of a carrier for bypassing the rumen and a component to bypass the rumen into a die head having at least one injection port;

applying vibration to the melt filled in the internal cavity of the die head, thereby injecting the melt from the injection port; and cooling the injected melt can be provided.

In an embodiment of the present invention, provided is a method for producing a rumen-bypassing preparation, comprising:

introducing a melt of a carrier for bypassing the rumen and a component to bypass the rumen into a die head having at least one injection port;

applying vibration to the melt filled in the internal cavity of the die head, thereby injecting the melt from the injection port; and

cooling the injected melt,

wherein the vibration is applied to the melt through a vibrator, which is exposed to the internal cavity of the die head and is directly in contact with the melt, and the vibration is vibration in the range of 1000 Hz to 10000 Hz.

In an aspect of the present invention, a rumen-bypassing preparation obtained by the method of the present invention is a granular agent, and has particle sizes of 700 μm or more. In an embodiment of the present invention, a rumen-bypassing preparation of the present invention is a granular agent, and has particle sizes of 1500 μm or less. In an embodiment of the present invention, a rumen-bypassing preparation of the present invention is a granular agent, and has particle sizes of 700 μm or more and 1500 μm or less. In an embodiment of the present invention, a rumen-bypassing preparation of the present invention is a granular agent, and 40 weight/weight %, 50 weight/weight % or more, 60 weight/weight %, or preferably 70 weight/weight % or more of the obtained granules have particle sizes of 700 μm or more and 1500 μm or less. In an aspect of the present invention, a rumen-bypassing preparation of the present invention is a granular agent, and 40 weight/weight %, 50 weight/weight % or more, 60 weight/weight %, or preferably 70 weight/weight % or more of the obtained granules have particle sizes of 1000 μm or more and 1500 μm or less. According to the present invention, a rumen-bypassing preparation of the present invention can be produced using a method of the present invention.

In an embodiment of the present invention, a rumen-bypassing preparation obtained by a method of the present invention is provided. In an embodiment of the present invention, a rumen-bypassing preparation obtained by a method of the present invention can have a pore volume of 5 μL/g or more, 10 μL/g or more, 20 μL/g or more, 30 μL/g or more, 40 μL/g or more, 50 μL/g or more, 60 μL/g or more, 70 μL/g or more, 80 μL/g or more, 90 μL/g or more, or 100 μL/g or more.

The stability of the obtained preparation can be evaluated by keeping the obtained preparation under the conditions of 40° C. and 75% RH, for example, for 2 months and quantifying the content of an active ingredient after storage.

The dissolution of the component contained from the obtained preparation can be evaluated by stirring the preparation in simulated ruminal fluid, for example, at 40° C. for 10 to 20 hours (for example, 16 hours) and analyzing the amount of the component dissolved. Although the analysis is not particularly limited, the component can be analyzed, for example, by high speed liquid chromatography. As the simulated ruminal fluid, for example, 900 mL of an aqueous solution containing 6.3 g of disodium hydrogen phosphate dodecahydrate (Na₂HPO₄. 12H₂O) and 6.7 g/L of potassium dihydrogen phosphate (KH₂PO₄) (pH 6.4) can be used.

Although the present invention will be described hereinafter by specific examples, the present invention is not limited to the following Examples.

### EXAMPLES

### Example 1: Preparation of Rumen-Bypassing Vitamin D₃ Preparation and Analysis of Obtained Preparation

### Example 1-1: Preparation of Rumen-Bypassing Vitamin D₃ Preparation and Measurement of Particle Size Distribution

In this example, a vitamin D₃ preparation is prepared, and its particle size distribution is shown.

100 kg of hydrogenated palm oil was melted at 72° C. To the melt was added 6.25 g of vitamin D₃ dissolved in soybean oil, and the mixture was stirred homogenously. The obtained solution was fed to a vibrating granulating device having a die hole diameter of 0.7 mm, vibration at 1000 to 10000 Hz was applied, and the obtained solution was injected into cool air. The particle size distribution of the solidified rumen-bypassing vitamin D₃ was measured on the basis of the particle size measurement method (sieving method) of the Japanese Pharmacopoeia. The vibration was a sine wave having a p-p value of 5 mm.

In the above, a vibrating granulating device 100 used in this example was as shown in FIG. 1. The vibrating granulating device 100 used in this example comprised the following configuration as shown in FIG. 1. The vibrating granulating device 100 comprised a die head 20, a vibration generator 10 and a vibration transmitter 11 which transmitted vibration directly to a solution. The die head 20 had the inlet port 21 of a melt 30 of the dispersed solution, and injection ports 22 which inject the melt 30 (although two injection ports 22a and 22b are drawn on the figure, the number of the injection ports is not limited to two). In this example, the vibrating granulating device 100 was operated as follows. That is, the above-mentioned melt 30 of the dispersed solution was introduced into the die head 20 through the melt inlet port 21 of the vibrating granulating device. The die head 20 was filled with the melt 30, and the vibration generator 10 was then operated. The vibration transmitter 11 was vibrated up and down as shown in an arrow of FIG. 1 while the melt 30 was fed to the die head 20. The melt 20 was injected from the injection ports 22 using this vibration. The injected melt 31 was released into cool air, cooled and solidified.

The result was as shown in Table 1 and FIG. 2.

TABLE 1
Particle Size Distribution

| Rumen- | | | | | | | | | | |
|---|---|---|---|---|---|---|---|---|---|---|
| bypassing | | | | | | | | | | |
| vitamin D₃ | Spraying | | Uniform droplet granulation method | | | | | | | |
| preparation | method | | 1000 Hz | | 3000 Hz | | 7000 Hz | | 10000 Hz | |
| Particle size | Weight | | Weight | | Weight | | Weight | | Weight | |
| (μm) | (g) | % | (g) | % | (g) | % | (g) | % | (g) | % |
| 1520≤ | 0.4 | 0.04 | 100.1 | 55.58 | 34.3 | 17.34 | 25.0 | 21.65 | 31.8 | 21.80 |
| 1000-1519 | 34.1 | 3.35 | 77.0 | 42.75 | 163.1 | 82.46 | 90.2 | 78.10 | 113.4 | 77.72 |
| 710-999 | 305.0 | 29.96 | 1.9 | 1.05 | 0.1 | 0.05 | 0.1 | 0.09 | 0.4 | 0.27 |
| 600-709 | 133.0 | 13.06 | 0.2 | 0.11 | 0 | 0.00 | 0 | 0.00 | 0.1 | 0.07 |
| 500-599 | 134.5 | 13.21 | 0.3 | 0.17 | 0 | 0.00 | 0.1 | 0.09 | 0.1 | 0.07 |
| ≤499 | 411.0 | 40.37 | 0.6 | 0.33 | 0.3 | 0.15 | 0.1 | 0.09 | 0.1 | 0.07 |
| Total (g) | 1018.0 | | 180.1 | | 197.8 | | 115.5 | | 145.9 | |

When the granules obtained by applying vibration at 3000 Hz were observed, as shown in FIG. 2, while the particle size was uneven and very small in the usual spraying method, the particle size is even, and most of the granules had particle sizes of 1000 μm or more in the method of the example of the present application.

As shown in Table 1, the granules produced by applying vibrations at any of the frequencies and injecting the melt had particle sizes of 1000 μm or more, and granules having particle sizes of 1000 μm to 1519 μm were very efficiently obtained especially when vibration at 3000 Hz to 10000 Hz was applied.

### Example 1-2: Structural Analysis of Obtained Granules

The granules having particle sizes of 1000 μm to 1519 μm were obtained from the obtained granules according to the sieving method of the Japanese Pharmacopoeia, and the granules were analyzed in further detail. In this example, especially the distribution of the pore size was analyzed.

The pore size was measured by mercury penetration using a mercury porosimeter. The pores size was measured using AutoPore III (manufactured by Micromeritics Instrument Corp.). The above-obtained granules having particle sizes of 1000 μm to 1519 μm was deaerated, mercury was penetrated into the granules. The relationship between the amount of mercury penetrated into the granules and the pressure applied at that time was investigated. The pores size was calculated by the Washburn Equation:

D=−4γCOS θ/P

wherein D is a pore size, γ is the surface tension of mercury (namely, 480 dyn/cm), and θ is the contact angle between mercury and the wall surfaces of pores (namely, 140°). The pores size distribution was calculated using data-processing software POREPLOT-PCW ver. 1.02 for porosimeters manufactured by SHIMADZU CORPORATION. The results were as shown in FIG. 5.

As shown in FIG. 5, when the granules obtained in this example were analyzed, pores of 0.04 μm to 0.3 μm were frequently observed in the granules. As to the cumulative pore volume, it was considered that pores sizes indicated with the region of the “a” of FIG. 5 were not the pores sizes of pores in granules, but are the pores sizes showing distances between different granules. Few pores exhibiting pores sizes indicated with the region of the “b” of FIG. 5 were observed. Many pores having pores sizes indicated with the region of the “c” of FIG. 5 were observed. The region of the “d” of FIG. 5 is a region where the errors of measurement by mercury penetration are large, and is not an evidence which suggests that pores exist.

When the volume of the pores in the granules was calculated by deducting the region of the “b” as the background from data of the pores included in the region of the “c” of FIG. 5 as to pores having sizes included in the “c”, it was found that the granules have a pore volume of around 0.0388 mL/g (38.8 μL/g).

### Example 1-3: Dissolution Test of Obtained Granules

Granules having particle sizes of 1000 μm or more was contained in the granules obtained in the above-mentioned Example 1-1 at a high rate. Since it was considered that granules having large particle sizes had high resistance to dissolution in the rumen, in this example, the dissolution resistance of the granules obtained in Example 1-1 was examined using simulated ruminal fluid. The dissolution resistance was specifically confirmed in the following procedure.

100 kg of hydrogenated palm oil was melted at 72° C. To the melt was added 6.25 g of vitamin D₃ dissolved in soybean oil, and the mixture was stirred homogenously. The obtained solution was fed to a vibrating granulating device having die holes diameter of 0.7 mm, vibration at 1000 to 10000 Hz was applied, and the obtained solution was injected into cool air. Granules of the solidified rumen-bypassing vitamin D₃ having particle sizes of 1000 μm to 1519 μm was collected separately, and the dissolution test was performed. In the dissolution test, 900 mL of an aqueous solution containing 6.3 g of disodium hydrogen phosphate dodecahydrate (Na₂HPO₄.12H₂O) and 6.7 g/L of potassium dihydrogen phosphate (KH₂PO₄) (pH 6.4) was specifically used as the simulated ruminal fluid, the granules having particle sizes of 1000 μm to 1519 μm were immersed in the above-mentioned simulated ruminal fluid, and the mixture was stirred at 40° C. for 16 hours. The dissolved active ingredient, namely dissolved vitamin D₃, was quantified after stirring using a Vitamin D₃ ELISA kit manufactured by Elabscience Biotechnology Inc. The detection limit in this example was 2.37% of the content.

Consequently, the amounts of the granules obtained by applying any of vibrations at 1000 Hz, 3000 Hz, 5000 Hz, 7000 Hz, and 10000 Hz to the granules and dissolved in the simulated ruminal fluid were the detection limit or less, and the dissolution could not be detected.

Thus, according to this example, it is apparent that granules having particle sizes of 1000 μm or more are efficiently obtained, these granules exhibit high dissolution resistance in the simulated ruminal fluid, and can be used suitably as a rumen-bypassing preparation.

### Example 2: Preparation of Rumen-Bypassing Lysine Preparation and Analysis of Obtained Preparation

### Example 2-1: Preparation of Rumen-Bypassing Lysine Preparation and Measurement of its Particle Size Distribution

In this example, a rumen-bypassing lysine preparation is prepared, and its particle size distribution is shown.

54.2 kg of hydrogenated rapeseed oil, 5.0 kg of stearic acid and 3.0 kg of lecithin were melted and mixed at 80° C. Particles containing 37.5 kg of lysine hydrochloride and 0.3 kg of calcium propionate (particle size: 0.3 mm) were added to this melted mixed solution, and the particles were dispersed homogeneously. The obtained dispersed solution was fed to the vibrating granulating device having a die hole diameter of 0.7 mm as a melt, and the melt was injected into cool air by applying vibration having a constant frequency of 3000 to 7000 Hz. The particle size distribution of the solidified rumen-bypassing lysine preparation was measured according to the method for measuring particle sizes (sieving method) of “1.3. granular agent” of the Japanese Pharmacopoeia. The granulated granules were specifically sieved using sieves having various pore sizes, and the weights (g) of the sieved fractions were measured.

The results were as shown in Table 2.

TABLE 2
Particle Size Distribution

| Rumen- | | | | | | | | |
|---|---|---|---|---|---|---|---|---|
| bypassing | | | | | | | | |
| lysine | | | Uniform droplet granulation method | | | | | |
| preparation | Spraying | | | | | | | |
| Particle size | method | | 3000 Hz | | 5000 Hz | | 7000 Hz | |
| (μm) | g | % | g | % | g | % | g | % |
| 1520≤ | 20.7 | 2.06 | 0.2 | 0.13 | 14.3 | 8.51 | 5.5 | 3.36 |
| 1000-1519 | 269.9 | 26.88 | 75.5 | 47.85 | 89.8 | 53.45 | 119.2 | 72.73 |
| 710-999 | 431.4 | 42.96 | 57.5 | 36.44 | 33.0 | 19.64 | 27.3 | 16.66 |
| 600-709 | 108.5 | 10.80 | 9.1 | 5.77 | 10.1 | 6.01 | 5.9 | 3.60 |
| 500-599 | 62.7 | 6.24 | 2.2 | 1.39 | 6.5 | 3.87 | 2.4 | 1.46 |
| ≤499 | 111.0 | 11.05 | 13.3 | 8.43 | 14.3 | 8.51 | 3.6 | 2.20 |
| Total (g) | 1004.2 | | 157.8 | | 168.0 | | 163.9 | |

As shown in Table 2, even granules having particle sizes of 710 to 1519 μm were obtained at all the vibrations, even granules having especially particle sizes of 1000 to 1519 μm were obtained, and most of the obtained granules were even granules having particle sizes of 1000 to 1519 μm at 5000 Hz to 7000 Hz.

### Example 2-2: Dissolution Test of Obtained Granules

In the above-mentioned Example 2-1, granules having particle sizes of 1000 μm to 1519 μm were separately obtained from granules obtained by vibration at 1000 Hz, 3000 Hz, 5000 Hz or 10000 Hz according to the sieving method of the Japanese Pharmacopoeia, and analyzed in further detailed. In this example, especially the dissolution of lysine from the obtained granules was investigated by the following dissolution test.

In the dissolution test, 900 mL of an aqueous solution containing 6.3 g of disodium hydrogen phosphate dodecahydrate (Na₂HPO₄.12H₂O) and 6.7 g/L of potassium dihydrogen phosphate (KH₂PO₄) (pH 6.4) was specifically used as the simulated ruminal fluid. The above-obtained granules having particle sizes of 1000 μm to 1519 μm were immersed in the above-mentioned simulated ruminal fluid, and the mixture was stirred at 40° C. for 16 hours. After stirring, the dissolved active ingredient was determined by reacting a ninhydrin solution (5 mg of ninhydrin, 8.5 mg of cupric chloride dihydrates, 24 mg of citric acid and 375 μL/mL of 2-methoxyethanol) with the solution containing the dissolved component by a usual method and measuring the absorbance at 475 nm. The results were as shown in Table 2-1.

TABLE 2-1
Dissolution of lysine from obtained preparation

| Frequency | 1000 Hz | 3000 Hz | 5000 Hz | 10000 Hz |
|---|---|---|---|---|
| Percent dissolution in simulated | 18.57 | 14.92 | 14.34 | 14.38 |
| ruminal fluid (%) | | | | |

As shown in Table 2-1, the preparation obtained by Example 2 exhibited resistance to the dissolution of the component contained in the simulated ruminal fluid. It was revealed that the obtained preparation was useful as a rumen-bypassing preparation from this.

### Example 2-3: Analysis of Pores in the Obtained Granules

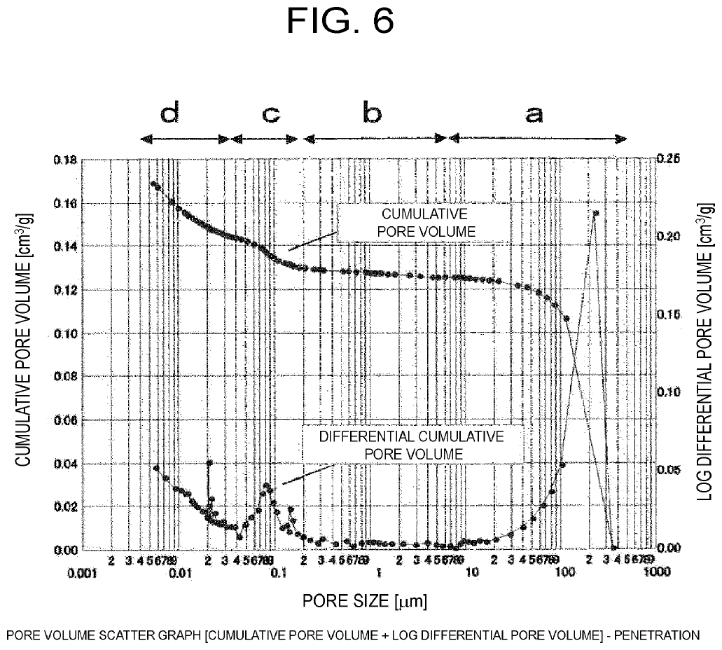

Granules having particle sizes of 1000 μm to 1519 μm were obtained according to the sieving method of the Japanese Pharmacopoeia from the granules obtained in the same way as in Example 1, and the pore size was analyzed. The results were as shown in FIG. 6.

When the granules obtained in this example were analyzed, pores of 0.04 μm to 0.3 μm were frequently observed in the granules as shown in FIG. 6. When the volume of the pores in the granules was calculated by deducting the region of the “b” as the background from data of the pores included in the region of the “c” of FIG. 6 as to pores having sizes included in the “c”, it was found that the granules have a pore volume of around 0.0182 mL/g (18.2 μL/g).

### Example 3: Preparation of Rumen-Bypassing Vitamin B-Methionine Preparation and Analysis of Obtained Preparation

### Example 3-1: Preparation of Rumen-Bypassing Vitamin B-Methionine Preparation and Measurement of its Particle Size Distribution

In this example, a vitamin B-methionine preparation is prepared, and its particle size distribution is shown.

22.5 kg of stearic acid, 10.0 kg of hydrogenated palm oil, 33.7 kg of hydrogenated rapeseed oil and 3.0 kg of lecithin were melted and mixed at 80° C. To this melted mixture were added particles containing 2 kg of nicotinic acid, 3.3 kg of D-calcium pantothenate, 15 kg of DL-methionine, 10 kg of betaine and 0.5 kg of silicic acid anhydride (particle size of 0.5 mm), and the particles were dispersed homogenously. As described in Example 1, the obtained dispersed solution was fed to the vibrating granulating device having a die hole diameter of 0.7 mm, and the obtained dispersed solution was injected into cool air by applying vibrations at 5000 to 10000 Hz. The particle size distribution of the solidified rumen-bypassing vitamin B-methionine preparation was measured on the basis of the particle size measurement method (sieving method) of the Japanese Pharmacopoeia.

The results were as shown in Table 3.

TABLE 3
Particle Size Distribution

| Rumen- | | | | | | | | |
|---|---|---|---|---|---|---|---|---|
| bypassing | | | | | | | | |
| vitamin B- | | | | | | | | |
| methionine | | | | | | | | |
| preparation | | | Uniform droplet granulation method | | | | | |
| Particle | Spraying method | | 5000 Hz | | 7000 Hz | | 10000 Hz | |
| size (μm) | g | % | g | % | g | % | g | % |
| 1520≤ | 0.4 | 0.66 | 13.0 | 9.24 | 18.7 | 11.11 | 17.2 | 14.10 |
| 1000-1519 | 18.1 | 29.67 | 88.4 | 62.83 | 85.9 | 51.04 | 59.6 | 48.85 |
| 710-999 | 28.6 | 46.89 | 30.1 | 21.39 | 37.2 | 22.10 | 28.0 | 22.95 |
| 600-709 | 7.0 | 11.48 | 2.3 | 1.63 | 10.8 | 6.42 | 6.0 | 4.92 |
| 500-599 | 3.5 | 5.74 | 0.9 | 0.64 | 4.2 | 2.50 | 3.1 | 2.54 |
| ≤499 | 3.4 | 5.57 | 6.0 | 4.26 | 11.5 | 6.83 | 8.1 | 6.64 |
| Total (g) | 61.0 | — | 140.7 | — | 168.3 | — | 122.0 | — |

As shown in Table 3, most of the granules produced by applying vibrations at 5000 to 10000 Hz and injecting the dispersed solution had particle sizes of 1000 to 1519 μm.

Thus, when the rumen-bypassing preparations containing various nutrients were produced, granules having particle sizes of 700 μm or more, preferably 1000 to 1519 μm, could be efficiently obtained by the methods of the present invention in Examples 1 to 3.

### Example 3-2: Dissolution Test of Obtained Granules

In the above-mentioned Example 3-1, granules having particle sizes of 1000 μm to 1519 μm were separately obtained from granules obtained by vibrations at 5000 Hz, 7000 Hz or 10000 Hz according to the sieving method of the Japanese Pharmacopoeia, and analyzed in further detailed. In this example, the dissolution of vitamin and the like from the obtained granules was investigated by the following dissolution test.

In the dissolution test, the proportions of nicotinic acid, methionine and calcium pantothenate dissolved in the simulated ruminal fluid were investigated. Specifically, 900 mL of an aqueous solution containing 6.3 g of disodium hydrogen phosphate dodecahydrate (Na₂HPO₄. 12 H₂O) and 6.7 g/L of potassium dihydrogen phosphate (KH₂PO₄) was used as the simulated ruminal fluid. The above-obtained granules having particle sizes of 1000 μm to 1519 μm were immersed in the above-mentioned simulated ruminal fluid, and the mixture was stirred at 40° C. for 16 hours. The dissolved active ingredient was analyzed by high speed liquid chromatography (column: Wakopak Handy ODS (Wako Pure Chemical Corporation) (4.6 mm in diameter×150 mm)) after stirring. The amounts of components dissolved were measured by measuring the absorbances at 210 nm using a UV absorbance detector (trade name: UV-970, manufacturer name: JASCO Corporation) by the usual method. The results were as shown in Tables 3-1 to 3-3.

TABLE 3-1
Dissolution of nicotinic acid from obtained preparation

| | | | |
|---|---|---|---|
| Frequency | 5000 Hz | 7000 Hz | 10000 Hz |
| Percent dissolution in | 6.3 | 6.1 | 6.8 |
| simulated ruminal fluid (%) | | | |

TABLE 3-2
Dissolution of D-calcium pantothenate from obtained preparation

| | | | |
|---|---|---|---|
| Frequency | 5000 Hz | 7000 Hz | 10000 Hz |
| Percent dissolution in | 12.9 | 12.1 | 12.7 |
| simulated ruminal fluid (%) | | | |

TABLE 3-3
Dissolution of methionine from obtained preparation

| | | | |
|---|---|---|---|
| Frequency | 5000 Hz | 7000 Hz | 10000 Hz |
| Percent dissolution in | 1.9 | 1.8 | 2.3 |
| simulated ruminal fluid (%) | | | |

As shown in Tables 3-1 to 3-3, the preparations obtained in Example 3 exhibited resistance to the dissolution of the components contained in the simulated ruminal fluid. It was revealed from this that the obtained preparations were useful as rumen-bypassing preparations.

### Example 3-3: Analysis of Pores in Obtained Granules

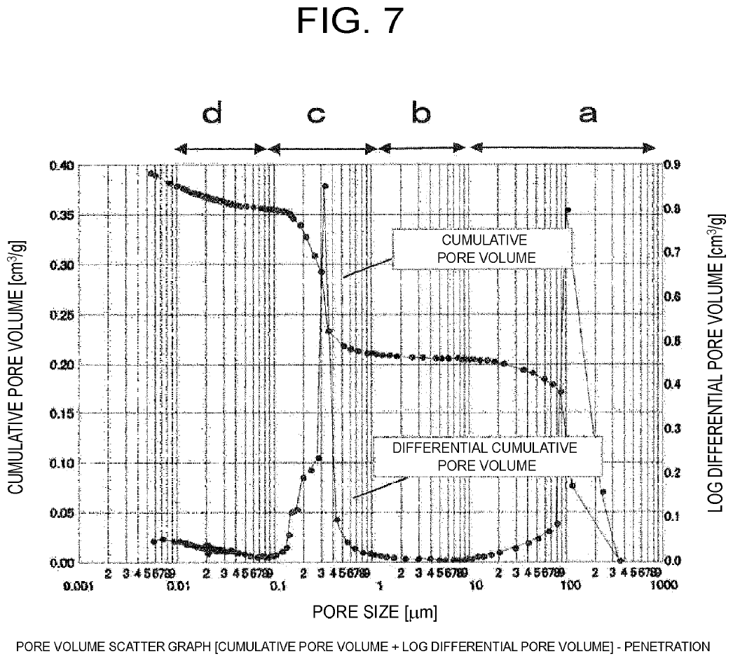

Granules having particle sizes of 1000 μm to 1519 μm were obtained from the granules obtained in the same way as in Example 1 according to the sieving method of Japanese Pharmacopoeia, and the pore sizes were analyzed. The results were as shown in FIG. 7.

As shown in FIG. 7, when the granules obtained in this example were analyzed, pores of 0.04 μm to 0.3 μm were frequently observed in the granules. When the volume of the pores in the granules was calculated by deducting the region of the “b” as the background from data of the pores included in the region of the “c” of FIG. 7 as to pores having sizes included in the “c”, it was found that the granules have a pore volume of around 0.1514 mL/g (151.4 μL/g).

It is found that the particle size of the obtained rumen-bypassing preparation becomes more uniform as the particle size of the component to bypass the rumen becomes smaller from the above-mentioned example. Meanwhile, even though granules of an active ingredient having a particle size of 0.5 mm was used relative to a die hole diameter of 0.7 mm, the uniformity of the particle sizes of the obtained rumen-bypassing preparation was maintained.

### Example 4: Stability Test of a Controlled Release Vitamin D₃ Preparation

In this example, the stability of a rumen bypass vitamin D₃ preparation was examined.

To sell a controlled release preparation, the preestimate of chemical change when the preparation was stored for a long term and the influence of the short-term deviation of storage conditions which can occur during distribution must be evaluated. Then, controlled release vitamin D₃ preparations were stored for two months under the conditions of 40° C. and 75% RH, and the contents of vitamin D₃ after storage were quantified using the p-anisaldehyde method. The results were as shown in Table 4.

TABLE 4
Particle Size and Stability of Granule

| Day 0 | 1000-1510 μm | 710-1000 μm | 600-710 μm | 500-600 μm | <500 μm |
|---|---|---|---|---|---|
| Predetermined | | | 2500 | | |
| content (IU/g) | | | | | |
| Measured content | 2714.27 | 2480.71 | −(3912.95) | 2787.58 | 2707.89 |
| (IU/g) | | | | | |
| Measured/ | 108.57 | 99.2 | −(156.5) | 111.50 | 108.32 |
| Predetermined (%) | | | | | |
| Day 30 | | | | | |
| Predetermined | | | 2500 | | |
| content (IU/g) | | | | | |
| Measured content | 2406.02 | 2307.60 | −(3795.08) | −(3683.834) | −(4929.97) |
| (IU/g) | | | | | |
| Measured/ | 96.25 | 92.30 | −(151.80) | −(147.35) | −(173.20) |
| Predetermined (%) | | | | | |
| Day 60 | | | | | |
| Predetermined | | | 2500 | | |
| content (IU/g) | | | | | |
| Measured content | 2812.094 | 2304.563 | −(5950.828) | −(5641.784) | −(3059.395) |
| (IU/g) | | | | | |
| Measured/ | 112.48 | 92.18 | −(238.03) | −(225.67) | −(122.38) |
| Predetermined (%) | | | | | |

As shown in Table 4, deviation of 20% or more from a predetermined value was observed in controlled release vitamin D preparations of less than 710 μm after storage for 30 days and 60 days. Meanwhile, it was not observed that the quantified values of vitamin D₃ in the granules having particle sizes of 710 to 1510 μm fluctuated greatly as compared with those before storage.

Next, it was found that controlled release vitamin D₃ preparations having particle sizes of 710 μm or more were stable at normal temperature for at least one year when a period in which the controlled release vitamin D₃ preparations were stable was presumed using Arrhenius' equation:

k=A exp(−Ea/RT)

wherein k represents the rate constant, A represents the constant independent of temperature, Ea represents the activation energy per mole, R represents the gas constant, and T represents absolute temperature. From the above results, it could be confirmed that granules having particle sizes of 710 μm or more, especially particle sizes of 1000 μm to 1510 μm, were excellent in storage stability.

### Example 5: Relationship Between Particle Size and Percent Bypass of Granules

In this example, the relationship between the particle size and the percent bypass (namely, the proportion of the active ingredient that passed the first stomach) of granules was investigated.

The lysine bypassing preparation was produced as described in Example 2. The bypassing preparation was sieved according to the particle size, and the percent bypass of the granules at particle sizes were investigated. The percent bypass was calculated as: Percent bypass=(Content of active ingredient−Amount of active ingredient dissolved in simulated first ruminal fluid)/Content of active ingredient

The simulated ruminal fluid was prepared as 900 mL of an aqueous solution containing 6.3 g of disodium hydrogen phosphate dodecahydrate (Na₂HPO₄.12H₂O) and 6.7 g/L of potassium dihydrogen phosphate (KH₂PO₄) (pH 6.4). The preparations were stirred in the simulated ruminal fluid at 40° C. for 16 hours. The results were as shown in Table 5.

TABLE 5
Relationship between particle size and percent bypass

| Particle size (μm) | -499 | 500-599 | 600-709 | 710-999 | 1000-1519 | 1520- |
|---|---|---|---|---|---|---|
| Percent bypass (%) | 7.27 | 14.87 | 29.52 | 57.53 | 78.99 | 69.12 |

As shown in Table 5, when the particle size was 709 μm or less, the percent bypass was as low as 30% or less. Meanwhile, when the particle size was more than 710 μm, the percent bypass which was more than 50% was achieved. Especially when the particle size was 1000 μm or more, the percent bypass was more than 60%. Further, when the particle size was 1000 μm to 1519 μm, the percent bypass reached around 80%.

According to the present invention, granules having a uniform particle size of 700 μm or more, especially a uniform particle size of 1000 μm to 1510 μm, can be obtained effectively. Therefore, based on the results of Example 4, the obtained granules are excellent in long-term stability. Based on the results of Example 5, the obtained granules have particle sizes in a range in which the percent bypass is high.

When the particle size is more than 2 mm, possibility that a granular agent is crushed by the mastication of a ruminant increases. Therefore, it is considered that a method in which granules of 1500 μm or less are obtained efficiently is very useful industrially. When the particle size is 700 μm or more, the granular agent is excellent in the stability of the preparation and the percent bypass at which the preparation passes through the first stomach. Therefore, it is considered that a method in which granules of 700 μm or more are obtained efficiently is very useful industrially. Therefore, the present invention which enables effectively obtaining granules having a uniform particle size of 700 μm or more, especially a uniform particle size of 1000 μm to 1510 μm, is an industrially very useful invention.

### REFERENCE SIGNS LIST

100: whole die head, 10: vibration generator, 11: vibrator, 20: outer wall of die head, 21: inlet port, 22a, 22b: injection ports, 30: internal cavity of die head filled with melt, 40a: granule of rumen-bypassing preparation containing particle containing component to bypass rumen, 40b: granule of rumen-bypassing preparation dissolving component to bypass rumen, 41: particle containing component to bypass rumen, 42: coating agent, 45: carrier dissolving component to bypass rumen

1. A method for producing a rumen-bypassing preparation, the method comprising
applying vibration to a die head containing a melt of a coating agent for the rumen-bypassing preparation and a nutrient to bypass a rumen and having at least one injection port or the melt contained in the die head, thereby injecting the melt from the injection port.

2. The method according to claim 1, wherein the vibration is vibration in the range of 1000 Hz to 10000 Hz.

3. The method according to claim 1, wherein the vibration is vibration in the range of 3000 Hz to 7000 Hz.

4. The method according to claim 1, wherein the vibration is applied to the melt through a vibrator, which is exposed to an internal cavity of the die head and is directly in contact with the melt.

5. The method according to claim 1, wherein the coating agent is a hydrogenated oil.

6. The method according to claim 5, wherein the hydrogenated oil is one or more hydrogenated oils selected from the group consisting of hydrogenated palm oil and hydrogenated rapeseed oil.

7. The method according to claim 1, wherein the coating agent further comprises one or more selected from the group consisting of a fatty acid and lecithin.

8. The method according to claim 1, wherein the nutrient is an amino acid or a vitamin.

9. The method according to claim 1, wherein the nutrient is at least one selected from the group consisting of lysine, methionine, vitamin B and vitamin D.

10. A rumen-bypassing preparation, comprising
a component to bypass a rumen and
a carrier for bypassing the rumen,
wherein the rumen-bypassing preparation is a granular agent wherein 40 weight/weight % or more of the total granules have particle sizes of 1000 to 1519 μm.

11. A rumen-bypassing preparation, comprising
a component to bypass a rumen and
a coating agent for the rumen-bypassing preparation,
wherein the rumen-bypassing preparation is a granular agent wherein 40 weight/weight % or more of the total granules have particle sizes of 1000 to 1519 μm.

12. The rumen-bypassing preparation according to claim 10, wherein the rumen-bypassing preparation has a pore volume of 5 μL/g or more.

13. A rumen-bypassing preparation, obtained by the method according to claim 1.
